(19) United States
(12) Patent Application Publication
(10) Pub. No.: US 2018/0108071 A1
(43) Pub. Date: Apr. 19, 2018

(54) IN-STORE CART SORTING SYSTEM

(71) Applicant: INTERNATIONAL BUSINESS MACHINES CORPORATION, Armonk, NY (US)

(72) Inventors: Venita H. Glasfurd, Littleton, MA (US); Chetan B. Jadhav, Bangalore (IN); Mansi Tewari, Bangalore (IN)

(21) Appl. No.: 15/298,095

(22) Filed: Oct. 19, 2016

(51) Int. Cl. G06Q 30/06; G06K 7/14

(52) U.S. Cl. CPC G06Q 30/0633; G06K 7/1413

(57) ABSTRACT

A method and system are provided for automatically sorting products. The method includes receiving, by an automatic multi-compartment cart sorting system from an order fulfillment system, order information for a plurality of products. The method further includes automatically sorting, by the automatic multi-compartment cart sorting system, the plurality of products based on the order information for the plurality of products by guiding each of the plurality of products into an allocated compartment, from among a plurality of compartments, in accordance with the order information.

### BACKGROUND

### Technical Field

The present invention relates generally to order fulfillment and, in particular, to an in-store cart sorting system.

### Description of the Related Art

An upcoming trend in the e-commerce space is that traditional brick and mortar stores now serve as fulfillment centers (apart from warehouses) to fulfill orders that are placed through various channels.

Picking products is one of the key steps in an order fulfillment scenario. The step includes collecting products in a specified quantity to satisfy customers' orders. To make picking more efficient, similar products are batched together and picked in a process called batch picking. While batch picking systems reduce the length of the path traversed by a picker, it still necessitates an additional step of sortation, where a picker needs to sort the products into their respective orders. In all systems, pickers manually sort products into compartments during picking or after picking. This manual process can be erroneous and time consuming. This sorting is also an additional step and hence the time taken for the entire picking process is not optimal.

Thus, there is a need for an improved sorting approach for order fulfillment.

### SUMMARY

According to an aspect of the present invention, a method is provided for automatically sorting products. The method includes receiving, by an automatic multi-compartment cart sorting system from an order fulfillment system, order information for a plurality of products. The method further includes automatically sorting, by the automatic multi-compartment cart sorting system, the plurality of products based on the order information for the plurality of products by guiding each of the plurality of products into an allocated compartment, from among a plurality of compartments, in accordance with the order information.

According to another aspect of the present invention, a computer program product is provided for automatically sorting products. The computer program product includes a non-transitory computer readable storage medium having program instructions embodied therewith. The program instructions are executable by a computer to cause the computer to perform a method. The method includes receiving, by an automatic multi-compartment cart sorting system from an order fulfillment system, order information for a plurality of products. The method further includes automatically sorting, by the automatic multi-compartment cart sorting system, the plurality of products based on the order information for the plurality of products by guiding each of the plurality of products into an allocated compartment, from among a plurality of compartments, in accordance with the order information.

According to yet another aspect of the present invention, a system is provided for automatically sorting products. The system includes an automatic multi-compartment cart sorting system, having a processor and a memory operably coupled to the processor. The automatic multi-compartment cart sorting system is configured to receive order information for a plurality of products from an order fulfillment system. The automatic multi-compartment cart sorting system is further configured to automatically sort the plurality of products based on the order information for the plurality of products by guiding each of the plurality of products into an allocated compartment, from among a plurality of compartments, in accordance with the order information.

These and other features and advantages will become apparent from the following detailed description of illustrative embodiments thereof, which is to be read in connection with the accompanying drawings.

### BRIEF DESCRIPTION OF DRAWINGS

The following description will provide details of preferred embodiments with reference to the following figures wherein:

FIG. 1 shows an exemplary processing system to which the present invention may be applied, in accordance with an embodiment of the present invention;

FIG. 2 shows an exemplary in-store cart sorting system, in accordance with an embodiment of the present invention; and

FIGS. 3-4 show an exemplary method for performing in-store cart sorting, in accordance with an embodiment of the present invention;

### DETAILED DESCRIPTION

The present invention is directed to an in-store cart sorting system.

In an embodiment, the present invention advantageously employs a multi-compartment picking cart with its own sortation system. A picker will pick and keep a product in a deposit tray. The sortation system connects to an order fulfillment system, for example, via Internet of Things (IoT) internetworking, and then moves the product into a specific compartment (bin) which is designated for a specific order in the batch.

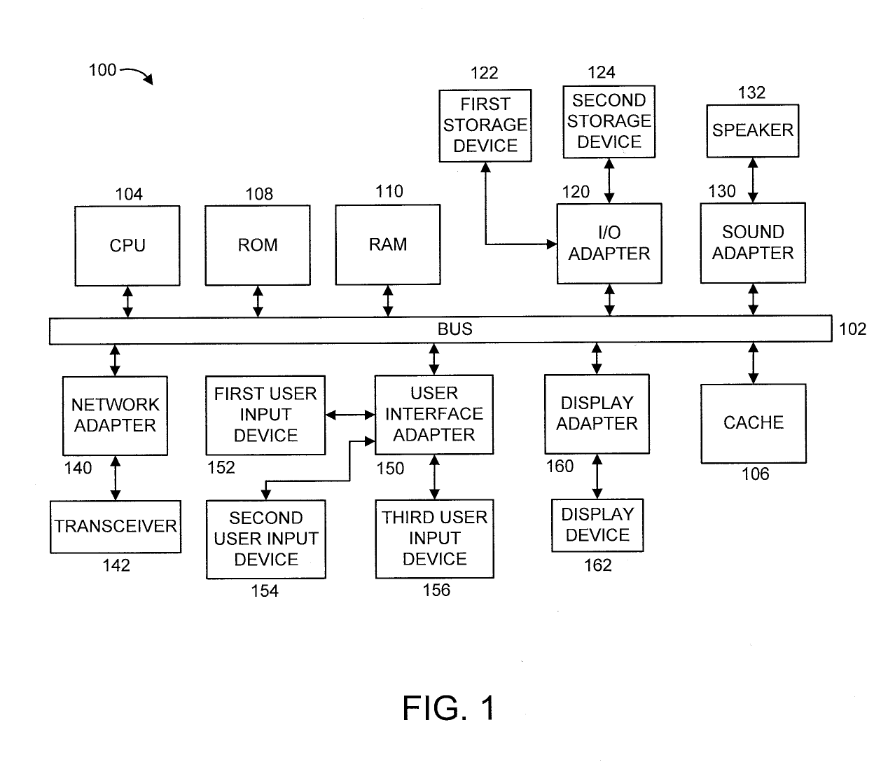

FIG. 1 shows an exemplary processing system 100 to which the invention principles may be applied, in accordance with an embodiment of the present invention. The processing system 100 includes at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160.

A first user input device 152, a second user input device 154, and a third user input device 156 are operatively coupled to system bus 102 by user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present invention. The user input devices 152, 154, and 156 can be the same type of user input device or different types of user input devices. The user input devices 152, 154, and 156 are used to input and output information to and from system 100.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present invention provided herein.

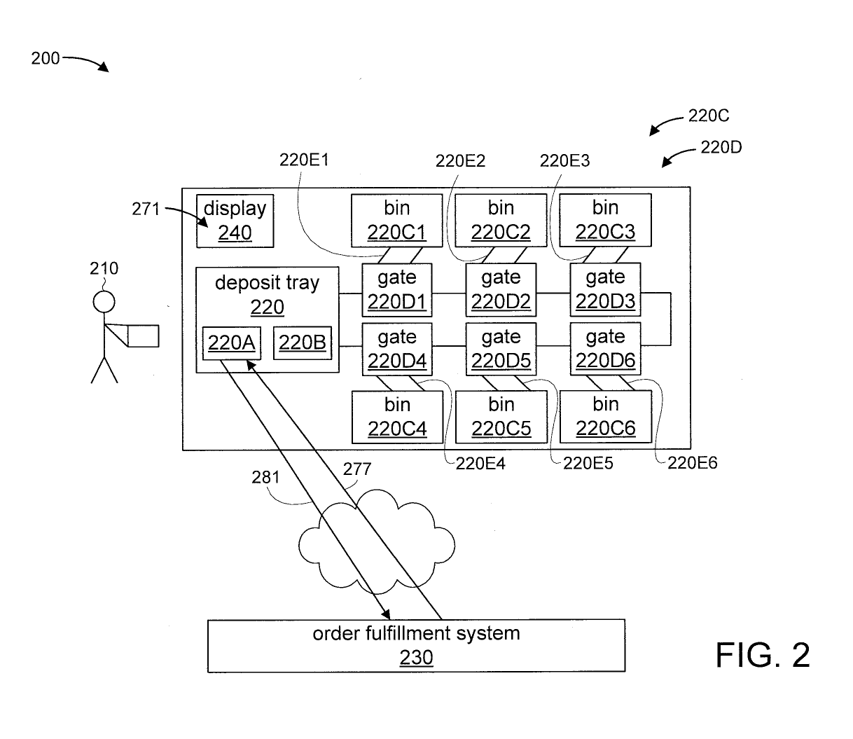

Moreover, it is to be appreciated that system 200 described below with respect to FIG. 2 is a system for implementing respective embodiments of the present invention. Part or all of processing system 100 may be implemented in one or more of the elements of system 200.

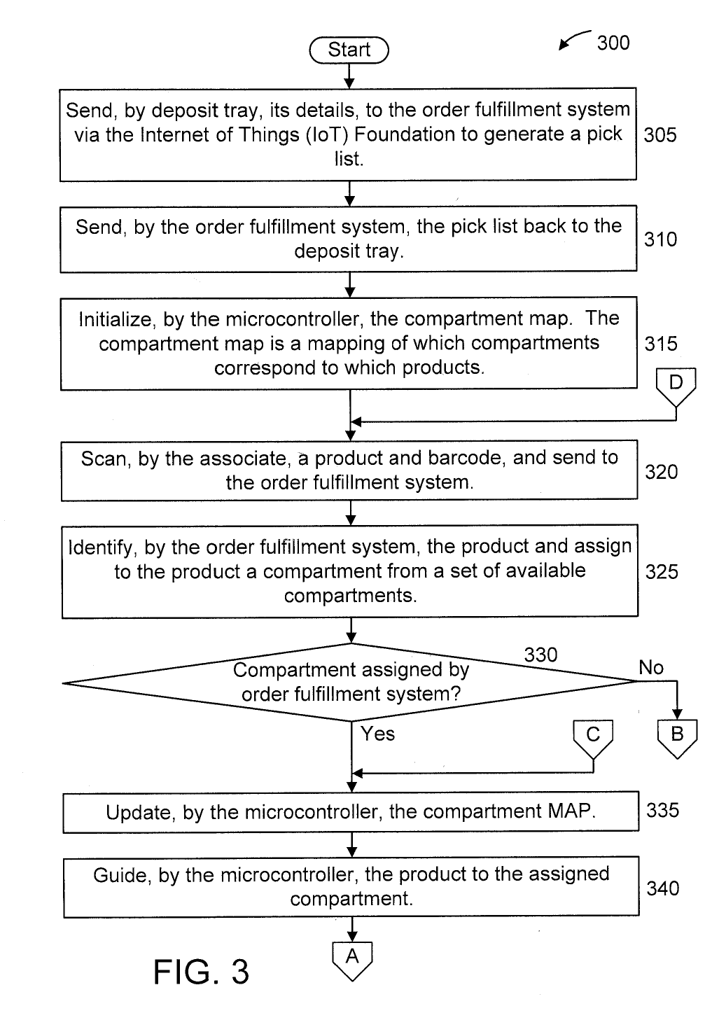

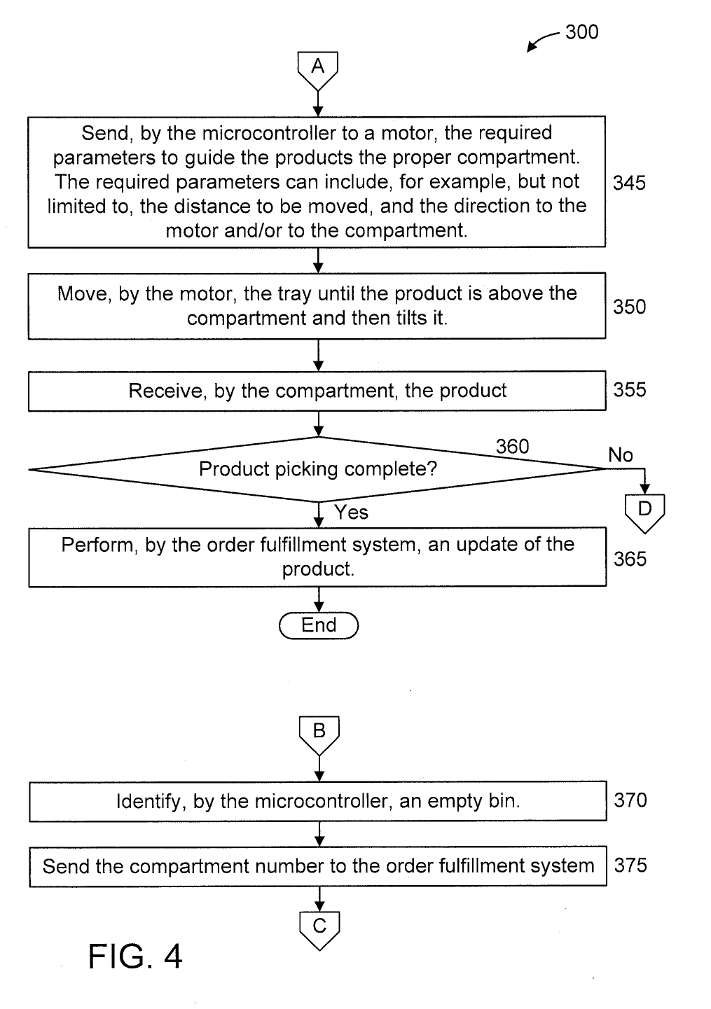

Further, it is to be appreciated that processing system 100 may perform at least part of the method described herein including, for example, at least part of method 300 of FIGS. 3-4. Similarly, part or all of system 200 may be used to perform at least part of method 300 of FIGS. 3-4.

FIG. 2 shows an exemplary in-store cart sorting system 200, in accordance with an embodiment of the present invention.

The in-store cart sorting system 200 includes and/or otherwise involves and/or interfaces with a picker 210, a deposit tray 220, an order fulfillment system 230, a visual display 240, and a motor 250. It is to be appreciated that the in-store cart sorting system 200 shown in FIG. 2 is shown of a given size for the sake of illustration. However, in an embodiment, it is contemplated that system 200 can be implemented in a mobile configuration similar in size to a shopping cart, although possibly bigger in other embodiments.

The picker 210 receives a batch pick list 271 of the products to be picked. This list 271 of products is rendered on the visual display 240. The picker 210 picks a particular product and places it on the deposit tray 220. The picker 210 can be a person, or can be an automated device such as a robot and/or other automated apparatus, and so forth, as ready appreciated by one of ordinary skill in the art.

The deposit tray 220 includes a programmable microcontroller 220A that is connected to a bar code scanner 220B. The programmable controller 220A can be, for example, but is not limited to, an Arduino® programmable controller. In an embodiment, the deposit tray 220 is registered with the Internet of Things (IoT) Foundation. The deposit tray 220 includes a scanning area.

A scanned bar code 281 is transmitted to the order fulfillment system by the deposit tray 220 by publishing an event to the IoT Foundation

The order fulfillment system 230 has a pre-configured priority based on which orders need to be filled. This priority is used to select/determine a compartment (interchangeably referred to as a “bin”), from among a set of compartments 220C, into which the product is to be placed. The compartment number 277 of the selected/determined is communicated to the cart. In the example of FIG. 2, the set of compartments 220C includes compartments/bins 220C1-C6.

The programmable microcontroller 220A is used to open a gate, from a respective set of gates 220D, into the correct (selected/determined) compartment, from among the set of compartments 220C, and the product flows down a conduit from a set of conduits 220E to the correct compartment. In the example of FIG. 2, the set of gates 220D includes compartments/bins 220D1-D6. In the example of FIG. 2, the set of conduits 220E includes conduits 220E1-E6.

In the embodiment shown in FIG. 2, the elements thereof are interconnected by a bus(es)/network(s) 201. However, in other embodiments, other types of connections can also be used. Moreover, in an embodiment, at least one of the elements of system 200 is processor-based. Further, while one or more elements may be shown as separate elements, in other embodiments, these elements can be combined as one element. The converse is also applicable, where while one or more elements may be part of another element, in other embodiments, the one or more elements may be implemented as standalone elements. Moreover, one or more elements of FIG. 2 can be implemented in a cloud configuration including, for example, in a distributed configuration. Additionally, one or more elements in FIG. 2 may be implemented by a variety of devices, which include but are not limited to, Digital Signal Processing (DSP) circuits, programmable processors, Application Specific Integrated Circuits (ASICs), Field Programmable Gate Arrays (FPGAs), Complex Programmable Logic Devices (CPLDs), and so forth. These and other variations of the elements of system 200 are readily determined by one of ordinary skill in the art, given the teachings of the present invention provided herein, while maintaining the spirit of the present invention.

FIGS. 3-4 show an exemplary method 300 for performing in-store cart sorting, in accordance with an embodiment of the present invention.

At step 305, send, by deposit tray, its details, to the order fulfillment system via the Internet of Things (IoT) Foundation to generate a pick list.

At step 310, send, by the order fulfillment system, the pick list back to the deposit tray.

At step 315, initialize, by the microcontroller, the compartment map. The compartment map is a mapping of which compartments correspond to which products. In this way, the products can be placed within the proper compartments during sorting.

At step 320, scan, by the associate, a product and barcode, and send to the order fulfillment system.

At step 325, identify, by the order fulfillment system, the product and assign to the product a compartment from a set of available compartments.

At step 330, determine whether or not the compartment has been assigned from the order fulfillment system. If so, then continue to step 335. Otherwise, continue to step 370.

At step 335, update, by the microcontroller, the compartment MAP.

At step 340, guide, by the microcontroller, the product to the assigned compartment.

At step 345, send, by the microcontroller to a motor, the required parameters to guide the products the proper compartment. The required parameters can include, for example, but not limited to, the distance to be moved, and the direction to the motor and/or to the compartment. Of course, other parameters and/or additional parameters can be used for further refinement and/or other purposes, as readily appreciated by one of ordinary skill in the art given, given the teachings of the present invention provided herein, while maintaining the spirit of the present invention.

At step 350, move, by the motor, the tray until the product is above the compartment and then tilts it.

At step 355, receive, by the compartment, the product. While one approach and corresponding hardware for supporting the same are described in FIGS. 3 and 2, respectively, regarding how the product is placed into a respective compartment from among a set of compartments, other approaches and corresponding hardware can also be used, as readily appreciated by one of ordinary skill in the art, while maintaining the spirit of the present invention.

At step 360, determine whether or not picking (of products) is complete. If so, then proceed to step 365. Otherwise, return to step 320.

At step 365, perform, by the order fulfillment system, an update of the product.

At step 370, identify, by the microcontroller, an empty bin.

At step 375, send the compartment number to the order fulfillment system.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A method for automatically sorting products, the method comprising:
receiving, by an automatic multi-compartment cart sorting system from an order fulfillment system, order information for a plurality of products; and
automatically sorting, by the automatic multi-compartment cart sorting system, the plurality of products based on the order information for the plurality of products by guiding each of the plurality of products into an allocated compartment, from among a plurality of compartments, in accordance with the order information.

2. The method of claim 1, wherein each of the plurality of compartments corresponds to a respective one of a plurality of different orders placed with the order fulfillment system.

3. The method of claim 1, wherein the order information is received from the order fulfillment system using the Internet of Things.

4. The method of claim 1, further comprising:
receiving a batch pick list of the products as at least part of the order information; and
rendering, on a visual display device, the batch pick list of the products.

5. The method of claim 1, further comprising scanning, by a bar code reader, a bar code of each of the plurality of products, responsive to placing each of the plurality of products within a scanning area of the automatic multi-compartment cart sorting system.

6. The method of claim 5, further comprising transmitting the bar code of the each of the plurality of products to the order fulfillment system by publishing an event using the Internet of Things.

7. The method of claim 1, wherein the order information comprises order fill priority information indicative of respective priorities for filling orders for the products.

8. The method of claim 7, wherein the order fill priority information governs into which of the plurality of compartments the products are guided into.

9. The method of claim 1, further comprising selectively opening, by a programmable controller of the automatic multi-compartment cart sorting system, a respective one of a plurality gates for corresponding ones of the plurality of products, each of the plurality of gates for providing ingress into a respective one of the plurality of compartments.

10. The method of claim 9, further comprising communicating a corresponding compartment identifier for each of the plurality of compartments to the programmable controller to enable gate selection for each of the plurality of gates.

11. The method of claim 1, wherein said automatically sorting step is configured to commence at a deposit tray that is common to each of the plurality of products, irrespective of whether the plurality of products include different products.

12. The method of claim 1, further comprising assigning, by a programmable controller, respective ones of the plurality of compartments to respective one of the plurality of products.

13. The method of claim 1, further comprising updating the order fulfillment system, responsive to the plurality of products being placed into the plurality of compartments.

14. The method of claim 1, wherein the automatic multi-compartment cart sorting system is comprised in a mobile product picking cart, the mobile product picking cart being configured for mobility through a facility having the plurality of products therein.

15. A computer program product for automatically sorting products, the computer program product comprising a non-transitory computer readable storage medium having program instructions embodied therewith, the program instructions executable by a computer to cause the computer to perform a method comprising:
receiving, by an automatic multi-compartment cart sorting system from an order fulfillment system, order information for a plurality of products; and
automatically sorting, by the automatic multi-compartment cart sorting system, the plurality of products based on the order information for the plurality of products by guiding each of the plurality of products into an allocated compartment, from among a plurality of compartments, in accordance with the order information.

16. A system for automatically sorting products, the system comprising:
an automatic multi-compartment cart sorting system, having a processor and a memory operably coupled to the processor, the automatic multi-compartment cart sorting system configured to:
receive order information for a plurality of products from an order fulfillment system; and
automatically sort the plurality of products based on the order information for the plurality of products by guiding each of the plurality of products into an allocated compartment, from among a plurality of compartments, in accordance with the order information.

17. The system of claim 16, wherein each of the plurality of compartments corresponds to a respective one of a plurality of different orders placed with the order fulfillment system.

18. The system of claim 16, further comprising
a programmable controller; and
a plurality of gates,
wherein the programmable controller is configured to selectively open a respective one of a plurality gates for corresponding ones of the plurality of products, each of the plurality of gates for providing ingress into a respective one of the plurality of compartments.

19. The system of claim 16, wherein the automatic multi-compartment cart sorting system is configured to commence automatic sorting at a deposit tray that is common to each of the plurality of products, irrespective of whether the plurality of products include different products.

20. The system of claim 16, wherein the automatic multi-compartment cart sorting system is comprised in a mobile product picking cart, the mobile product picking cart being configured for mobility through a facility having the plurality of products therein.
